(19) United States
(12) Patent Application Publication
(10) Pub. No.: US 2020/0082290 A1
(43) Pub. Date: Mar. 12, 2020

(54) ADAPTIVE ANONYMIZATION OF DATA USING STATISTICAL INFERENCE

(71) Applicant: International Business Machines Corporation, Armonk, NY (US)

(72) Inventors: Alessandra Pascale, Dublin (IE); Naoise Holohan, Dublin (IE); Pierpaolo Tommasi, Dublin (IE); Stephane Deparis, Dublin (IE)

(21) Appl. No.: 16/127,694

(22) Filed: Sep. 11, 2018

(51) Int. Cl. G06N 7/00; G06N 99/00; G06N 7/08; G06F 21/62

(52) U.S. Cl. CPC G06N 7/005; G06F 21/6254; G06N 7/08; G06N 99/005

(57) ABSTRACT

Techniques that facilitate adaptive anonymization of data using statistical inference are provided. In one example, a system includes an anonymization component and a statistical learning component. The anonymization component applies an anonymization strategy to data associated with an electronic device. The statistical learning component modifies the anonymization strategy to generate an updated anonymization strategy for the data based on a machine learning process associated with a probabilistic model that represents the data.

### STATEMENT REGARDING FEDERALLY SPONSORED RESEARCH OR DEVELOPMENT

This invention was made with Government support under Contract No.: 689996 awarded by European Research Project. The Government has certain rights to this invention.

### BACKGROUND

The subject disclosure relates to data security systems, and more specifically, to data privacy and content protection.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that facilitate adaptive anonymization of data using statistical inference are described.

According to an embodiment, a system can comprise an anonymization component and a statistical learning component. The anonymization component can apply an anonymization strategy to data associated with an electronic device. The statistical learning component can modify the anonymization strategy to generate an updated anonymization strategy for the data based on a machine learning process associated with a probabilistic model that represents the data.

According to another embodiment, a computer-implemented method is provided. The computer-implemented method can comprise applying, by a system operatively coupled to a processor, an anonymization strategy to data associated with an electronic device. The computer-implemented method can also comprise learning, by the system, from anonymized data associated with the anonymization strategy to generate an updated anonymization strategy for the data based on a machine learning process associated with a probabilistic model that represents the data.

According to yet another embodiment, a computer program product for facilitating adaptive anonymization using statistical inference can comprise a computer readable storage medium having program instructions embodied therewith. The program instructions can be executable by a processor and cause the processor to apply, by the processor, a noise profile indicative of randomized data to data associated with an electronic device. The program instructions can also cause the processor to learn, by the processor, from the randomized data to generate an updated noise profile for the data based on a machine learning process associated with a probabilistic model that represents the data.

### DESCRIPTION OF THE DRAWINGS

FIG. 1 illustrates a block diagram of an example, non-limiting system that includes a data processing component in accordance with one or more embodiments described herein.

FIG. 2 illustrates a block diagram of another example, non-limiting system that includes a data processing component in accordance with one or more embodiments described herein.

FIG. 3 illustrates a block diagram of yet another example, non-limiting system that includes a data processing component in accordance with one or more embodiments described herein.

FIG. 4 illustrates an example, non-limiting system that includes an electronic device and an artificial intelligence system in accordance with one or more embodiments described herein.

FIG. 5 illustrates an example, non-limiting system for adaptive anonymization of data using statistical inference in accordance with one or more embodiments described herein.

FIG. 6 illustrates another example, non-limiting system for adaptive anonymization of data using statistical inference in accordance with one or more embodiments described herein.

FIG. 7 illustrates a block diagram of an example, non-limiting system that includes a client component in accordance with one or more embodiments described herein.

FIG. 8 illustrates a block diagram of an example, non-limiting system that includes a server component in accordance with one or more embodiments described herein.

FIG. 9 illustrates a flow diagram of an example, non-limiting computer-implemented method for facilitating adaptive anonymization of data using statistical inference in accordance with one or more embodiments described herein.

FIG. 10 illustrates a block diagram of an example, non-limiting operating environment in which one or more embodiments described herein can be facilitated.

FIG. 11 illustrates a block diagram of an example, non-limiting cloud computing environment in accordance with one or more embodiments of the present invention.

FIG. 12 illustrates a block diagram of example, non-limiting abstraction model layers in accordance with one or more embodiments of the present invention.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

In this regard, the amount of data generated and/or stored by computer systems increases daily. Furthermore, importance of protection of data generated and/or stored by a computer system is also increasing. For instance, quantity of personal data being collected is increasing due to an increased demand for personalized services and/or improved services (e.g., geolocation data concerning wireless networks, geolocation of users, data from wearable devices, data from Internet of Things devices, health-related data, user usage habits, etc.). However, increased system complexity and/or greater quantity of data increases risk of sensitive data leakage. As such, data anonymization can be employed to protect data generated and/or stored by a computer system. Data anonymization generally includes encryption of data, hashing of data, pseudonymization of data and/or other data processing techniques. However, data anonymization generally requires knowledge of properties of data being generated and/or stored. Furthermore, accuracy of conventional data anonymization techniques can be improved.

Embodiments described herein include systems, computer-implemented methods, and computer program products that provided adaptive anonymization of data using statistical inference. In an aspect data collected by a system can infer one or more properties of raw data (e.g., domain, correlations, etc.) via a statistical learning process. Based on the inferred one or more properties, an updated anonymization strategy (e.g., an updated differential privacy strategy) can be distributed to one or more electronic devices to continue collection of data by the one or more electronic devices. For instance, in an embodiment, based on the inferred one or more properties, a sever can transmit an updated anonymization strategy (e.g., an updated differential privacy strategy) to one or more client devices to continue collection of data by the one or more client devices. In an embodiment, an anonymization engine and a statistical learning engine can be employed with a feedback loop to allow the statistical learning engine to update (e.g., repeatedly update) the anonymization engine. In certain embodiments, randomized noise can be applied to data. Furthermore, one or more characteristics of the randomized noise can be determined based on one or more probabilistic models for the data that learn one or more features and/or one or more inferences associated with the data. In certain embodiments, an update to the anonymization strategy can be checked by the one or more electronic devices to authenticate anonymization properties of the updated anonymization strategy and/or prevent a certain type of update to the one more electronic devices. As such, accuracy of anonymized data can be improved. Security, and/or quality of data can therefore also be provided. Moreover, accuracy of data generated by a machine learning process can be improved, quality of data generated by a machine learning process can be improved, speed of data generated by a machine learning process can be improved, and/or a cost for analyzing data using a machine learning process can be reduced. Accuracy and/or efficiency of a machine learning model associated with data anonymization can also be provided.

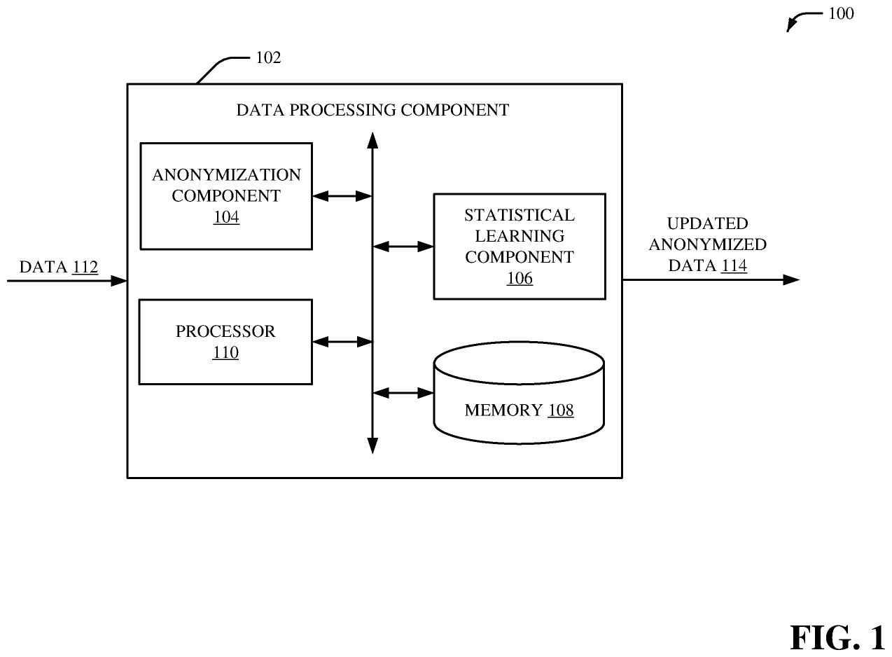

FIG. 1 illustrates a block diagram of an example, non-limiting system 100 that facilitates adaptive anonymization of data using statistical inference in accordance with one or more embodiments described herein. In various embodiments, the system 100 can be a system associated with technologies such as, but not limited to, computer technologies, server technologies, server/client technologies, Internet of Things technologies, cloud computing technologies, information technologies, machine learning technologies, artificial intelligence technologies, digital technologies, data anonymization technologies, data privacy technologies, content protection technologies, data processing technologies, data analysis technologies, and/or other computer technologies. The system 100 can employ hardware and/or software to solve problems that are highly technical in nature, that are not abstract and that cannot be performed as a set of mental acts by a human. Further, some of the processes performed may be performed by one or more specialized computers (e.g., one or more specialized processing units, a specialized computer with a data processing component, etc.) for carrying out defined tasks related to machine learning. The system 100 and/or components of the system can be employed to solve new problems that arise through advancements in technologies mentioned above, and/or computer architecture, and the like. One or more embodiments of the system 100 can provide technical improvements to computer systems, server systems, server/client systems, Internet of Things systems, cloud computing systems, information systems, machine learning systems, artificial intelligence systems, digital systems, data anonymization systems, data privacy systems, content protection systems, data processing systems, data analysis systems, and/or other systems. One or more embodiments of the system 100 can also provide technical improvements to a processing unit (e.g., a processor) associated with a data anonymization process by improving processing performance of the processing unit, improving processing efficiency of the processing unit, and/or reducing an amount of time for the processing unit to perform a data anonymization process. One or more embodiments of the system 100 can also provide technical improvements to a server/client computing environment (e.g., a server/client computing platform) by improving processing performance of the server/client computing environment and/or improving processing efficiency of the server/client computing environment. In one example, the system 100 can be associated with a data processing process and/or a data anonymization process.

In the embodiment shown in FIG. 1, the system 100 can include a data processing component 102. As shown in FIG. 1, the data processing component 102 can include an anonymization component 104 and a statistical learning component 106. Aspects of the data processing component 102 can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. In an aspect, the data processing component 102 can also include memory 108 that stores computer executable components and instructions. Furthermore, the data processing component 102 can include a processor 110 to facilitate execution of the instructions (e.g., computer executable components and corresponding instructions) by the data processing component 102. As shown, the anonymization component 104, the statistical learning component 106, the memory 108 and/or the processor 110 can be electrically and/or communicatively coupled to one another in one or more embodiments.

The data processing component 102 (e.g., the anonymization component 104 of the data processing component 102) can receive data 112. The data 112 can be generated by one or more electronic devices. Additionally or alternatively, the data 112 can be stored in one or more databases that receives and/or stores the data 112 associated with the one or more electronic devices. The one or more electronic devices can include one or more user devices such as, for example, one or more computing devices, one or more computers, one or more desktop computers, one or more laptop computers, one or more monitor devices, one or more smart devices, one or more smart phones, one or more mobile devices, one or more handheld devices, one or more tablets, one or more wearable devices, one or more portable computing devices, one or more medical devices, one or more sensor devices, one or more controller devices, and/or or one or more other computing devices. In an aspect, the data 112 can be digital data. Furthermore, the data 112 can include one or more types of data, such as but not limited to, electronic device data, user device data, sensor data, network data, metadata, user data, geolocation data, wearable device data, health-related data, medical imaging data, audio data, image data, video data, textual data and/or other data. In an embodiment, the data 112 can be raw data. In another embodiment, at least a portion of the data 112 can be encoded data and/or processed data. In an aspect, the data 112 can be associated with one or more identifying features. Additionally or alternatively, the data 112 can be associated with a user identity. For instance, the data 112 can be identifying data that can identify one or more features and/or one or more characteristics of a user.

The anonymization component 104 can apply an anonymization strategy to the data 112. The anonymization strategy can be an anonymization technique to remove one or more identifying features from the data 112. For instance, the anonymization strategy can be a statistical technique to remove one or more identifying features from the data 112. In one example, the anonymization strategy can be a differential privacy technique to remove one or more identifying features from the data 112. For instance, the anonymization strategy can be a differential privacy technique that adds randomized noise data to the data 112 to remove one or more identifying features from the data 112. In an embodiment, the anonymization strategy employed by the anonymization component 104 can include anonymized data. The anonymized data associated with the anonymization strategy can be applied to the data 112 to remove one or more identifying features from the data 112. In one example, the anonymized data can include the randomized noise data. In another example, the anonymized data can be a set of parameters of the anonymization strategy.

The statistical learning component 106 can modify the anonymization strategy to generate an updated anonymization strategy for the data 112. For instance, the statistical learning component 106 can modify the anonymization strategy to generate an updated anonymization strategy for the data 112 based on a machine learning process associated with a probabilistic model that represents the data 112. In an embodiment, the statistical learning component 106 can learn from the anonymized data associated with the anonymization strategy to generate an updated anonymization strategy for the data 112. For instance, the statistical learning component 106 can learn from the anonymized data associated with the anonymization strategy to generate an updated anonymization strategy for the data 112 based on a machine learning process associated with a probabilistic model that represents the data 112. The updated anonymization strategy can be an updated anonymization technique to remove one or more identifying features from the data 112. For instance, the updated anonymization strategy can be an updated statistical technique to remove one or more identifying features from the data 112. In one example, the updated anonymization strategy can be an updated differential privacy technique to remove one or more identifying features from the data 112. For instance, the updated anonymization strategy can be an updated differential privacy technique that adds updated randomized noise data to the data 112 to remove one or more identifying features from the data 112. In an embodiment, the updated anonymization strategy employed by the anonymization component 104 can include updated anonymized data 114. The updated anonymized data 114 associated with the updated anonymization strategy can be applied to the data 112 to remove one or more identifying features from the data 112. In one example, the updated anonymized data 114 can include a set of updated parameters for the updated anonymization strategy. In another example, the updated anonymized data 114 can include the updated randomized noise data. In certain embodiments, the anonymization component 104 can apply a noise profile associated with the anonymization strategy to the data 112. The noise profile can be indicative of randomized data. Furthermore, the statistical learning component 106 can learn from the randomized data to generate an updated noise profile for the data 112 based on the machine learning process associated with the probabilistic model that represents the data 112.

The machine learning process employed by the statistical learning component 106 can be associated with a machine learning network. For instance, the machine learning process can be a process that determines classifications, correlations, inferences and/or expressions associated with the data 112 and/or the anonymized data based on principles of artificial intelligence and/or one or more machine learning techniques. In certain embodiments, the machine learning process can be a deep learning process associated with a deep learning network. The deep learning network can be an artificial neural network that employs deep learning to determine at least one feature associated with the data 112 and/or the anonymized data. The deep learning network can, for example, employ supervised learning to determine at least one feature associated with the data 112 and/or the anonymized data. Furthermore, the deep learning network can process information similar to a biological neuron system that employs a cascade of multiple layers of nonlinear processing where a first layer can employ output of a second layer as input for the first layer. In certain embodiments, the machine learning process can be a convolutional neural network process associated with a convolutional neural network. The convolutional neural network can be a feed-forward artificial neural network that employs deep learning to determine at least one feature associated with the data 112 and/or the anonymized data. Furthermore, the convolutional neural network can be a classifier associated with supervised learning to determine at least one feature associated with the data 112 and/or the anonymized data. For instance, the convolutional neural network can include a set of convolutional layers that apply one or more convolutional operations to the data 112 and/or the anonymized data. However, it is to be appreciated that in certain embodiments the statistical learning component 106 can employ another type of machine learning process. In certain embodiments, the statistical learning component 106 can train the machine learning process based on training data received from an electronic device that is different than the electronic device associated with the data 112 and/or the anonymized data.

The probabilistic model associated with the machine learning process can be a model employed by the machine learning process to determine classifications, correlations, inferences and/or expressions associated with the data 112 and/or the anonymized data. The probabilistic model can employ a probabilistic distribution of the data 112 and/or the anonymized data to determine classifications, correlations, inferences and/or expressions associated with the data 112 and/or the anonymized data. In an embodiment, the probabilistic model can be a statistical learning model that employs statistics and/or functional analysis to determine classifications, correlations, inferences and/or expressions associated with the data 112 and/or the anonymized data. As such, in an embodiment, the statistical learning component 106 can modify the anonymization strategy based on a statistical learning model. In another embodiment, the probabilistic model can be a Bayesian network model that employs Bayesian statistics and/or a probabilistic graph that represents the data 112 and/or the anonymized data to determine classifications, correlations, inferences and/or expressions associated with the data 112 and/or the anonymized data. As such, in another embodiment, the statistical learning component 106 can modify the anonymization strategy based on a Bayesian network model. In yet another embodiment, the probabilistic model can be a Markov chain model that employs a probability distribution represented as a Markov chain transition matrix associated with the data 112 and/or the anonymized data to determine classifications, correlations, inferences and/or expressions associated with the data 112 and/or the anonymized data. As such, in yet another embodiment, the statistical learning component 106 can modify the anonymization strategy based on a Markov chain model. Moreover, the statistical learning component 106 can additionally or alternatively learn from the data 112 and/or the anonymized data based on a statistical learning model, a Bayesian network model, and/or a Markov chain model. However, it is to be appreciated that in certain embodiments the statistical learning component 106 can additionally or alternatively learn from the data 112 and/or the anonymized data based on a different type of machine learning model.

In an embodiment, the anonymization component 104 can apply the updated anonymization strategy to the data 112 via a feedback loop between the statistical learning component 106 and the anonymization component 104. For instance, the anonymization component 104 can apply the updated anonymized data 114 associated with the updated anonymization strategy to the data 112 via a feedback loop between the statistical learning component 106 and the anonymization component 104. In certain embodiments, the statistical learning component 106 can learn from the anonymized data and/or the data 112 in response to a determination that a timer satisfies a defined criterion. For example, the statistical learning component 106 can generate an updated anonymization strategy for the data 112 in response to a determination that a certain amount of time has passed since a previous updated anonymization strategy for the data 112 is determined. In certain embodiments, the statistical learning component 106 can modify the machine learning process in response to a determination that a timer satisfies a defined criterion.

It is to be appreciated that the data processing component 102 (e.g., the anonymization component 104 and/or the statistical learning component 106) performs a data processing process and/or a data anonymization process that cannot be performed by a human (e.g., is greater than the capability of a single human mind). For example, an amount of data processed, a speed of processing of data and/or data types processed by the data processing component 102 (e.g., the anonymization component 104 and/or the statistical learning component 106) over a certain period of time can be greater, faster and different than an amount, speed and data type that can be processed by a single human mind over the same period of time. The data processing component 102 (e.g., the anonymization component 104 and/or the statistical learning component 106) can also be fully operational towards performing one or more other functions (e.g., fully powered on, fully executed, etc.) while also performing the above-referenced data processing process and/or data anonymization process. Moreover, the data processing component 102 (e.g., the anonymization component 104 and/or the statistical learning component 106) can include information that is impossible to obtain manually by a user. For example, a type of information included in the updated anonymized data 114, an amount of information included in the updated anonymized data 114 and/or a variety of information included in the updated anonymized data 114 can be more complex than information obtained manually by a user.

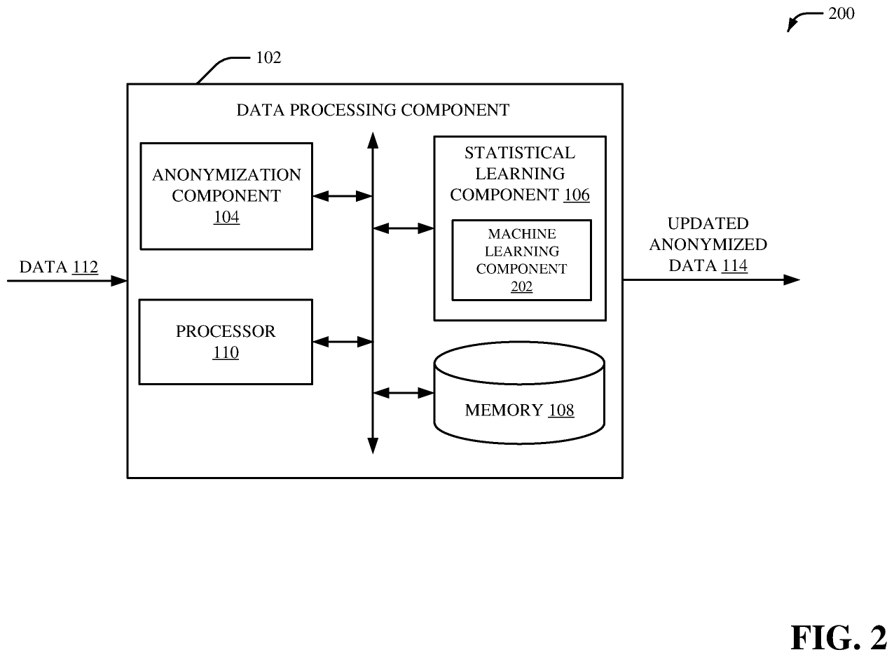

FIG. 2 illustrates a block diagram of an example, non-limiting system 200 in accordance with one or more embodiments described herein. Repetitive description of like elements employed in other embodiments described herein is omitted for sake of brevity.

The system 200 includes the data processing component 102. The data processing component 102 can include the anonymization component 104, the statistical learning component 106, the memory 108 and/or the processor 110. In an embodiment, the statistical learning component 106 can include a machine learning component 202. The machine learning component 202 can employ principles of artificial intelligence to facilitate statistical learning associated with the data 112 and/or generation of the updated anonymized data 114. The machine learning component 202 can perform learning with respect to the data 112 and/or the anonymized data explicitly or implicitly. In an aspect, the machine learning component 202 can perform statistical learning associated with the data 112 and/or the anonymized data based on classifications, correlations, inferences and/or expressions associated with principles of artificial intelligence. For instance, the machine learning component 202 can employ an automatic classification system and/or an automatic classification process to perform statistical learning associated with the data 112 and/or the anonymized data. In one example, the machine learning component 202 can employ a probabilistic and/or statistical-based analysis (e.g., factoring into the analysis utilities and costs) to learn and/or generate inferences with respect to the data 112. In an aspect, the machine learning component 202 can include an inference component (not shown) that can further enhance automated aspects of the machine learning component 202 utilizing in part inference based schemes to facilitate statistical learning associated with the data 112 and/or the anonymized data. The machine learning component 202 can employ any suitable machine-learning based techniques, statistical-based techniques and/or probabilistic-based techniques. For example, the machine learning component 202 can employ statistical learning models, Bayesian models (e.g., Bayesian networks), Markov chain models, Hidden Markov Models (HMMs), expert systems, fuzzy logic, SVMs, greedy search algorithms, rule-based systems, neural networks, other non-linear training techniques, data fusion, utility-based analytical systems, systems employing Bayesian models, etc. In another aspect, the machine learning component 202 can perform a set of machine learning computations associated with statistical learning associated with the data 112 and/or the anonymized data. For example, the machine learning component 202 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations to perform statistical learning associated with the data 112 and/or the anonymized data.

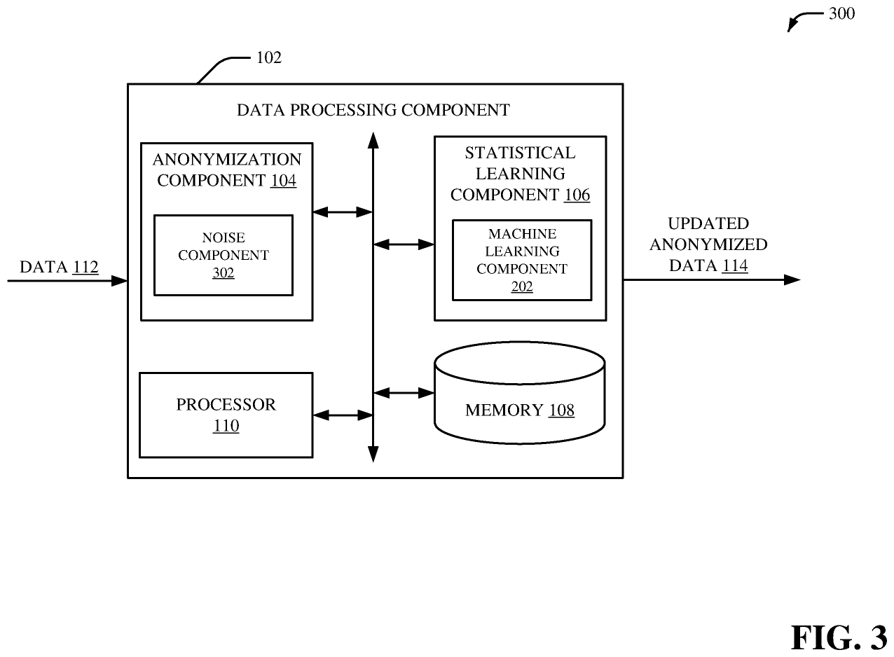

FIG. 3 illustrates a block diagram of an example, non-limiting system 300 in accordance with one or more embodiments described herein. Repetitive description of like elements employed in other embodiments described herein is omitted for sake of brevity.

The system 300 includes the data processing component 102. The data processing component 102 can include the anonymization component 104, the statistical learning component 106, the memory 108 and/or the processor 110. In an embodiment, the statistical learning component 106 can include the machine learning component 202. Additionally or alternatively, the anonymization component 104 can include a noise component 302. The noise component 302 can generate randomized noise data to add to the data 112. For example, the noise component 302 can determine the randomized noise data based on one or more probabilistic models for the data 112 that learn one or more features and/or one or more inferences associated with the data 112. In an embodiment, the noise component 302 can apply a noise profile indicative of randomized data (e.g., the randomized noise data) to the data 112. Furthermore, the statistical learning component 106 can learn from the randomized data to generate an updated noise profile for the data 112 based on a machine learning process associated with a probabilistic model that represents the data 112. In one example, the statistical learning component 106 can learn from the randomized data to generate an updated noise profile for the data 112 based on a machine learning process associated with a statistical learning model that represents the data 112. In another example, the statistical learning component 106 can learn from the randomized data to generate an updated noise profile for the data 112 based on a machine learning process associated with a Bayesian network model that represents the data 112. In yet another example, the statistical learning component 106 can learn from the randomized data to generate an updated noise profile for the data 112 based on a machine learning process associated with a Markov chain model that represents the data 112. However, it is to be appreciated that in certain embodiments the statistical learning component 106 can learn from the randomized data to generate an updated noise profile for the data 112 based on a different type of machine learning model. The updated noise profile can be applied to the data 112, for example, to remove one or more identifying features from the data 112.

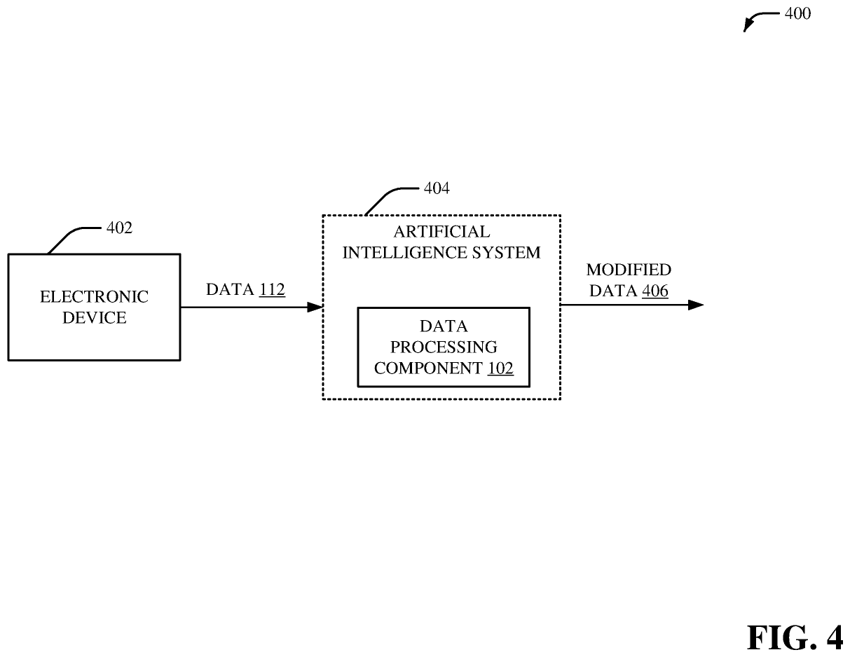

FIG. 4 illustrates an example, non-limiting system 400 in accordance with one or more embodiments described herein. Repetitive description of like elements employed in other embodiments described herein is omitted for sake of brevity.

The system 400 includes an electronic device 402 and an artificial intelligence system 404. The electronic device 402 can be a user device (e.g., a client device) such as, for example, a computing device, a computer, a desktop computer, a laptop computer, a monitor device, a smart device, a smart phone, a mobile device, a handheld device, a tablet, a wearable device, a portable computing device, a medical device, a sensor device, a controller device, and/or or another computing device. The artificial intelligence system 404 can include the data processing component 102. In one example, the artificial intelligence system 404 can be a server system to facilitate execution of one or more machine learning algorithms, execution of one or more application programming interfaces associated with machine learning, etc. In an embodiment, the electronic device 402 can provide the data 112 to the data processing component 102 associated with the artificial intelligence system 404 via a network. For instance, the network can include one or more wireless networks and/or one or more wired networks, including but not limited to, a wide area network (WAN, e.g., the Internet), a local area network (LAN), a cellular network, and/or another type of network. In certain embodiments, the network can be associated with one or more network devices (e.g., network hardware, network equipment, computer networking devices, etc.) to facilitate communication of the data 112 to the artificial intelligence system 404. In certain embodiments, the artificial intelligence system 404 (e.g., the data processing component 102 of the artificial intelligence system 404) can generate modified data 406. The modified data 406 can be a modified version of the data 112. For example, the modified data 406 can be an anonymized version of the data 112 that anonymizes one or more identifying features included in the data 112.

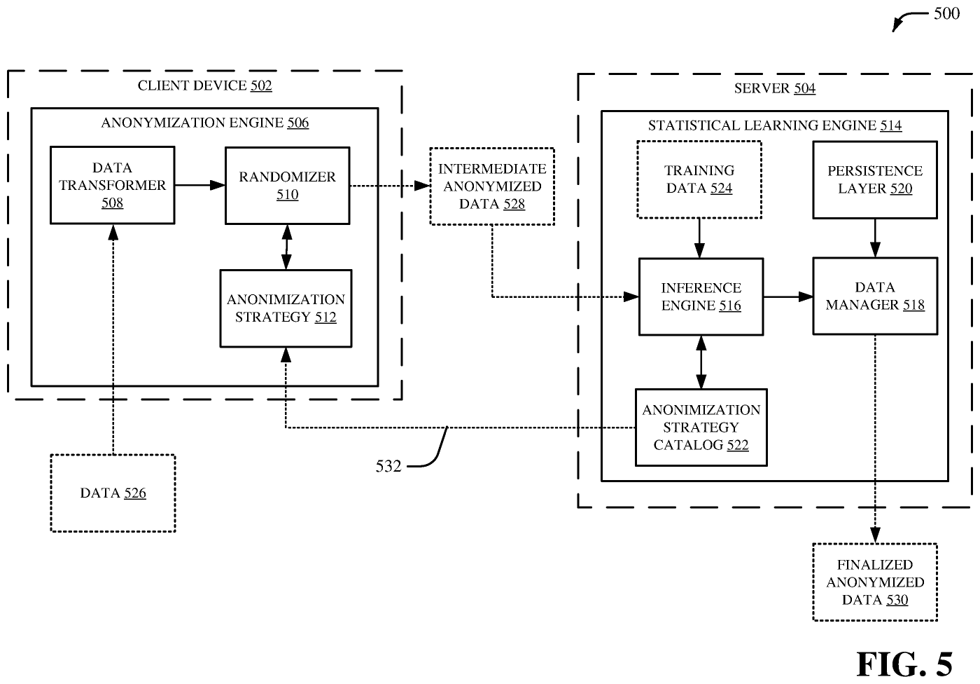

FIG. 5 illustrates an example, non-limiting system 500 in accordance with one or more embodiments described herein. Repetitive description of like elements employed in other embodiments described herein is omitted for sake of brevity.

The system 500 includes a client device 502 and a server 504. The client device 502 can be, for example, an electronic device. For instance, the client device 502 can be an electronic device (e.g., a user device) such as, for example, a computing device, a computer, a desktop computer, a laptop computer, a monitor device, a smart device, a smart phone, a mobile device, a handheld device, a tablet, a wearable device, a portable computing device, a medical device, a sensor device, a controller device, and/or or another computing device. The server 504 can be a device implemented, for example, via a cloud computing platform. In an embodiment, the client device 502 can be in communication with the server 504 via a network. For instance, the network can include one or more wireless networks and/or one or more wired networks, including but not limited to, a wide area network (WAN, e.g., the Internet), LAN, a cellular network, and/or another type of network. In certain embodiments, the network can be associated with one or more network devices (e.g., network hardware, network equipment, computer networking devices, etc.) to facilitate communication between the client device 502 and the server 504.

The client device 502 can include an anonymization engine 506. The anonymization engine 506 can include a data transformer 508, a randomizer 510 and/or an anonymization strategy 512. The server 504 can include a statistical learning engine 514. The statistical learning engine 514 can include an inference engine 516, a data manager 518, a persistence layer 520, an anonymization strategy catalog 522 and/or training data 524. In certain embodiments, the anonymization engine 506 can illustrate functionality of the anonymization component 104 and/or the statistical learning engine 514 can illustrate functionality of the statistical learning component 106. In an embodiment, data 526 can be provided to the anonymization engine 506. For instance, the data 526 can be provided to the data transformer 508. The data 526 can correspond to, for example, the data 112 provided to the data processing component 102. In an aspect, the data 526 can be generated by one or more electronic devices. Additionally or alternatively, the data 526 can be stored in one or more databases that receives and/or stores the data 526 associated with the one or more electronic devices. The one or more electronic devices can include one or more user devices such as, for example, one or more computing devices, one or more computers, one or more desktop computers, one or more laptop computers, one or more monitor devices, one or more smart devices, one or more smart phones, one or more mobile devices, one or more handheld devices, one or more tablets, one or more wearable devices, one or more portable computing devices, one or more medical devices, one or more sensor devices, one or more controller devices, and/or or one or more other computing devices. In an aspect, the data 526 can be digital data. Furthermore, the data 526 can include one or more types of data, such as but not limited to, electronic device data, user device data, sensor data, network data, metadata, user data, geolocation data, wearable device data, health-related data, medical imaging data, audio data, image data, video data, textual data and/or other data. In an embodiment, the data 526 can be raw data. In another embodiment, at least a portion of the data 526 can be encoded data and/or processed data. In an aspect, the data 526 can be associated with one or more identifying features. Additionally or alternatively, the data 526 can be associated with a user identity. For instance, the data 526 can be identifying data that can identify one or more features and/or one or more characteristics of a user. The data transformer 508 can be employed to transform the data 526. For instance, the data transformer 508 can encode the data 526 to facilitate anonymization of the data 526. In an aspect, the data transformer 508 can encode the data 526 into a vector based on a hash function technique.

The randomizer 510 can add randomized noise to the encoded version of the data 526. In an embodiment, the randomizer 510 can apply the anonymization strategy 512 to the encoded version of the data 526 to generate intermediate anonymized data 528. In one example, the randomizer 510 can apply a noise profile associated with the anonymization strategy 512 to the data 526. The anonymization strategy 512 can be an anonymization technique to remove one or more identifying features from the data 526. For instance, the anonymization strategy 512 can be a statistical technique to remove one or more identifying features from the data 526. In one example, the anonymization strategy 512 can be a differential privacy technique to remove one or more identifying features from the data 526. For instance, the anonymization strategy 512 can be a differential privacy technique that adds randomized noise data to the data 526 to remove one or more identifying features from the data 526. In an embodiment, the anonymization strategy 512 can include anonymized data. The anonymized data associated with the anonymization strategy 512 can be applied to the data 526 to remove one or more identifying features from the data 526. The intermediate anonymized data 528 can be an anonymized version of the data 526 with respect to individual privatized data.

The statistical learning engine 514 can be employed to further anonymize the intermediate anonymized data 528. In an embodiment, the inference engine 516 can infer one or more properties of the intermediate anonymized data 528. For example, the inference engine 516 can infer a domain of the intermediate anonymized data 528, one or more correlations associated with the intermediate anonymized data 528, etc. The inference engine 516 can infer the one or more properties of the intermediate anonymized data 528 based on statistical learning. In an embodiment, the inference engine 516 can perform a machine learning process associated with a probabilistic model that represents the data 526 and/or the intermediate anonymized data 528. For instance, the inference engine 516 can learn from the intermediate anonymized data 528 based on a statistical learning model, a Bayesian network model, a Markov chain model and/or another machine learning model. In certain embodiment, the inference engine 516 can train the machine learning process based on the training data 524. In an aspect, the training data 524 can be received from an electronic device that is different than an electronic device associated with the data 526. The data manager 518 can manage data generated by the inference engine 516. In certain embodiments, the data manager 518 can employ the persistence layer 520 to facilitate communication between a database. For example, the persistence layer 520 can map structured objects to a persistence implementation to perform data retrieval and/or updates associated with a database. In an aspect, the data manager 518 can provide finalized anonymized data 530. The finalized anonymized data 530 can be a further anonymized version of the data 526. For example, the finalized anonymized data 530 can be an anonymized version of the data 526 with respect to population privatized data. In an aspect, one or more identifying features included in the data 526 can be removed from the finalized anonymized data 530. The finalized anonymized data 530 can, for example, correspond to the updated anonymized data 114 provided by the data processing component 102. In certain embodiments, the inference engine 516 can update the anonymization strategy catalog 522 that includes a set of anonymization strategies to anonymize data. For example, the inference engine 516 can generate an updated anonymization strategy for the data 526 based on the machine learning process executed by the inference engine 516. The updated anonymization strategy can be applied to the data 526 via a feedback loop 532. For example, in an embodiment, the anonymization strategy 512 employed by the anonymization engine 506 can be an updated anonymization strategy determined by the inference engine 516 and transmitted to the anonymization engine 506 via the feedback loop 532. In certain embodiments, the inference engine 516 can generate an updated anonymization strategy for the data 526 in response to a determination that a timer satisfies a defined criterion. For example, the inference engine 516 can generate an updated anonymization strategy for the data 526 in response to a determination that a certain amount of time has passed since a previous updated anonymization strategy for the data 526 is determined. Additionally or alternatively, the inference engine 516 can learn from the machine learning process executed by the inference engine 516 in response to a determination that a timer satisfies a defined criterion. In an embodiment, the server 504 can be employed without allowing the server 504 to store or access the data 526. As such, improved anonymization and/or privacy of the data 526 can be provided to benefit client-side privatization of the data 526.

In a non-limiting example where an objective is to produce differentially private output associated with the data 526 whose accuracy improves over time, accuracy of the anonymization engine 506 can improve over time by learning on aggregated differentially private outputs of the anonymization engine 506 via the statistical learning engine 514. The anonymization engine 506 can be updated at discrete time intervals to improve accuracy while also maintaining a certain degree of differential privacy. For example, one or more differential privacy parameters (e.g., epsilon, delta, etc.) can remain unchanged through a data anonymization process to ensure that a certain degree of differential privacy is maintained. The differential privacy mechanism being updated can be the anonymization strategy 512, which can transform the data 526 (e.g., sensitive data) into the intermediate anonymized data 528 (e.g., noisy/anonymized data) that can be transmitted to the server 504 that includes the statistical learning engine 514. The update to the anonymization strategy 512 can be performed by the statistical learning engine 514 and can include, for example, modifying the anonymization strategy 512, distribution of random noise associated with the anonymization strategy 512, domain of output data (e.g., a smaller subset of an original domain), or another update to the anonymization strategy 512.

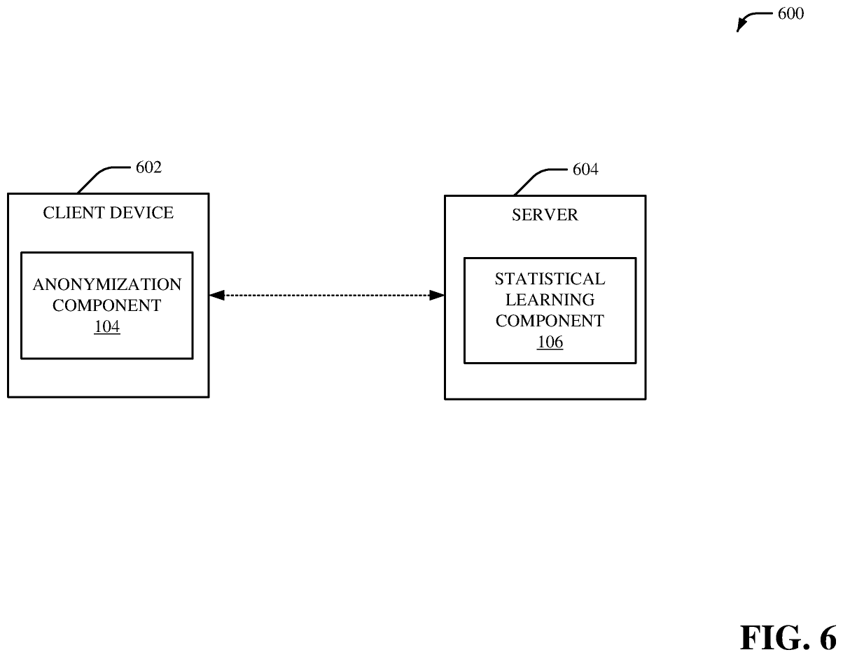

FIG. 6 illustrates an example, non-limiting system 600 in accordance with one or more embodiments described herein. Repetitive description of like elements employed in other embodiments described herein is omitted for sake of brevity.

The system 600 includes a client device 602 and a server 604. The client device 602 can be, for example, an electronic device. For instance, the client device 602 can be an electronic device (e.g., a user device) such as, for example, a computing device, a computer, a desktop computer, a laptop computer, a monitor device, a smart device, a smart phone, a mobile device, a handheld device, a tablet, a wearable device, a portable computing device, a medical device, a sensor device, a controller device, and/or or another computing device. The server 604 can be a device implemented, for example, via a cloud computing platform. In an embodiment, the client device 602 can be in communication with the server 604 via a network. For instance, the network can include one or more wireless networks and/or one or more wired networks, including but not limited to, a wide area network (WAN, e.g., the Internet), a LAN, a cellular network, and/or another type of network. In certain embodiments, the network can be associated with one or more network devices (e.g., network hardware, network equipment, computer networking devices, etc.) to facilitate communication between the client device 602 and the server 604. In an embodiment, the client device 602 can include the anonymization component 104. Additionally or alternatively, in an embodiment, the server 604 can include the statistical learning component 106. For example, in certain embodiments, the anonymization component 104 can be designed as a client-side deployment. Additionally or alternatively, in certain embodiments, the statistical learning component 106 can be designed as a server-side deployment. The anonymization component 104 can, for example, be associated with the anonymization engine 506. Additionally or alternatively, the statistical learning component 106 can be associated with the statistical learning engine 514.

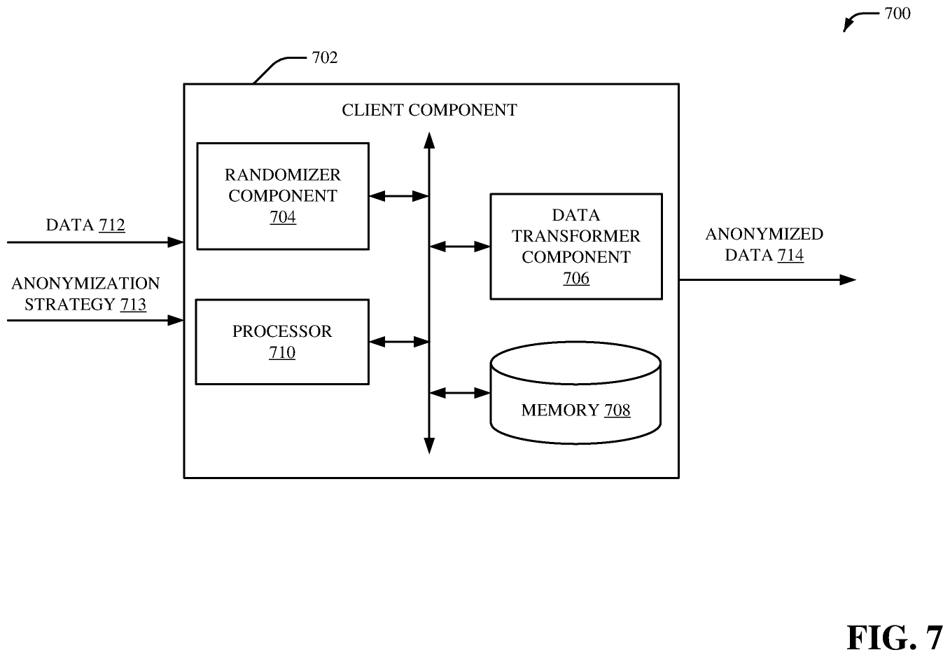

FIG. 7 illustrates a block diagram of an example, non-limiting system 700 that facilitates adaptive anonymization of data using statistical inference in accordance with one or more embodiments described herein. Repetitive description of like elements employed in other embodiments described herein is omitted for sake of brevity. In various embodiments, the system 700 can be a system associated with technologies such as, but not limited to, computer technologies, server technologies, server/client technologies, Internet of Things technologies, cloud computing technologies, information technologies, machine learning technologies, artificial intelligence technologies, digital technologies, data anonymization technologies, data privacy technologies, content protection technologies, data processing technologies, data analysis technologies, and/or other computer technologies. The system 700 can employ hardware and/or software to solve problems that are highly technical in nature, that are not abstract and that cannot be performed as a set of mental acts by a human. Further, some of the processes performed may be performed by one or more specialized computers (e.g., one or more specialized processing units, a specialized computer with a client component, etc.) for carrying out defined tasks related to machine learning. The system 700 and/or components of the system can be employed to solve new problems that arise through advancements in technologies mentioned above, and/or computer architecture, and the like. One or more embodiments of the system 700 can provide technical improvements to computer systems, server systems, server/client systems, Internet of Things systems, cloud computing systems, information systems, machine learning systems, artificial intelligence systems, digital systems, data anonymization systems, data privacy systems, content protection systems, data processing systems, data analysis systems, and/or other systems. One or more embodiments of the system 700 can also provide technical improvements to a processing unit (e.g., a processor) associated with a data anonymization process by improving processing performance of the processing unit, improving processing efficiency of the processing unit, and/or reducing an amount of time for the processing unit to perform a data anonymization process. One or more embodiments of the system 700 can also provide technical improvements to a server/client computing environment (e.g., a server/client computing platform) by improving processing performance of the server/client computing environment and/or improving processing efficiency of the server/client computing environment. In one example, the system 700 can be associated with a data processing process and/or a data anonymization process.

In the embodiment shown in FIG. 7, the system 700 can include a client component 702. As shown in FIG. 7, the client component 702 can include a randomizer component 704 and a data transformer component 706. Aspects of the client component 702 can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. In an aspect, the client component 702 can also include memory 708 that stores computer executable components and instructions. Furthermore, the client component 702 can include a processor 710 to facilitate execution of the instructions (e.g., computer executable components and corresponding instructions) by the client component 702. As shown, the randomizer component 704, the data transformer component 706, the memory 708 and/or the processor 710 can be electrically and/or communicatively coupled to one another in one or more embodiments. In an embodiment, the client component 702 can be implemented on a client device. Additionally, the client component 702 can be in communication with a server.

The client component 702 (e.g., the randomizer component 704 of the client component 702) can receive data 712. The data 712 can be generated by one or more electronic devices. Additionally or alternatively, the data 712 can be stored in one or more databases that receives and/or stores the data 712 associated with the one or more electronic devices. The one or more electronic devices can include one or more user devices such as, for example, one or more computing devices, one or more computers, one or more desktop computers, one or more laptop computers, one or more monitor devices, one or more smart devices, one or more smart phones, one or more mobile devices, one or more handheld devices, one or more tablets, one or more wearable devices, one or more portable computing devices, one or more medical devices, one or more sensor devices, one or more controller devices, and/or or one or more other computing devices. In certain embodiments, the one or more electronic devices can include a client device that includes the client component 702. In an aspect, the data 712 can be digital data. Furthermore, the data 712 can include one or more types of data, such as but not limited to, electronic device data, user device data, sensor data, network data, metadata, user data, geolocation data, wearable device data, health-related data, medical imaging data, audio data, image data, video data, textual data and/or other data. In an embodiment, the data 712 can be raw data. In another embodiment, at least a portion of the data 712 can be encoded data and/or processed data. In an aspect, the data 712 can be associated with one or more identifying features. Additionally or alternatively, the data 712 can be associated with a user identity. For instance, the data 712 can be identifying data that can identify one or more features and/or one or more characteristics of a user. Additionally, the client component 702 (e.g., the data transformer component 706 of the client component 702) can receive an anonymization strategy 713. The anonymization strategy 713 can be an anonymization technique to remove one or more identifying features from the data 712. For instance, the anonymization strategy 713 can be a statistical technique to remove one or more identifying features from the data 712. In one example, the anonymization strategy 713 can be a differential privacy technique to remove one or more identifying features from the data 712. For instance, the anonymization strategy 713 can be a differential privacy technique that adds randomized noise data to the data 712 to remove one or more identifying features from the data 712. In an embodiment, the anonymization strategy 713 can include anonymized data. The anonymized data associated with the anonymization strategy 713 can be applied to the data 712 to remove one or more identifying features from the data 712. In one example, the anonymized data can include the randomized noise data. In certain embodiments, the anonymization strategy 713 can be an updated anonymization strategy generated based on a machine learning process associated with a probabilistic model that represents the data 712. For example, the anonymization strategy 713 can be an updated noise profile for the data 712 that is generated based on a machine learning process associated with a probabilistic model that represents the data 712. In certain embodiments, the anonymization strategy 713 can be received from a server. In an embodiment, the randomizer component 704 can apply the anonymization strategy 713 to the data 712. For example, the randomizer component 704 can apply a noise profile indicative of randomized data to the data 712. In an embodiment, the client component 702 can generate anonymized data 714. The anonymized data 714 can be a version of the data 712 where one or more identifying features are removed from the data 112.

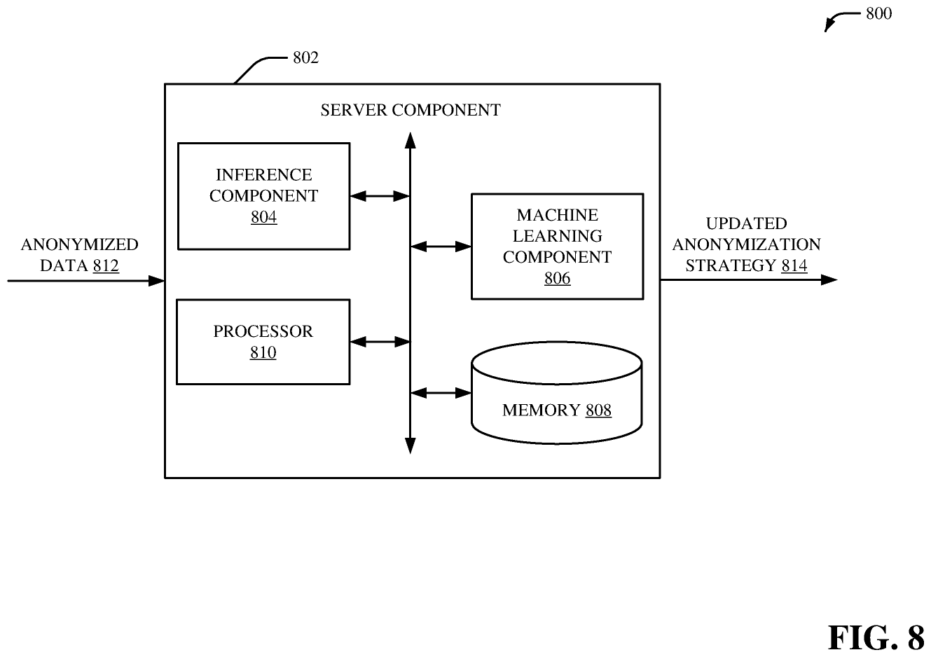

FIG. 8 illustrates a block diagram of an example, non-limiting system 800 that facilitates adaptive anonymization of data using statistical inference in accordance with one or more embodiments described herein. Repetitive description of like elements employed in other embodiments described herein is omitted for sake of brevity. In various embodiments, the system 800 can be a system associated with technologies such as, but not limited to, computer technologies, server technologies, server/client technologies, Internet of Things technologies, cloud computing technologies, information technologies, machine learning technologies, artificial intelligence technologies, digital technologies, data anonymization technologies, data privacy technologies, content protection technologies, data processing technologies, data analysis technologies, and/or other computer technologies. The system 800 can employ hardware and/or software to solve problems that are highly technical in nature, that are not abstract and that cannot be performed as a set of mental acts by a human. Further, some of the processes performed may be performed by one or more specialized computers (e.g., one or more specialized processing units, a specialized computer with a server component, etc.) for carrying out defined tasks related to machine learning. The system 800 and/or components of the system can be employed to solve new problems that arise through advancements in technologies mentioned above, and/or computer architecture, and the like. One or more embodiments of the system 800 can provide technical improvements to computer systems, server systems, server/client systems, Internet of Things systems, cloud computing systems, information systems, machine learning systems, artificial intelligence systems, digital systems, data anonymization systems, data privacy systems, content protection systems, data processing systems, data analysis systems, and/or other systems. One or more embodiments of the system 800 can also provide technical improvements to a processing unit (e.g., a processor) associated with a data anonymization process by improving processing performance of the processing unit, improving processing efficiency of the processing unit, and/or reducing an amount of time for the processing unit to perform a data anonymization process. One or more embodiments of the system 800 can also provide technical improvements to a server/client computing environment (e.g., a server/client computing platform) by improving processing performance of the server/client computing environment and/or improving processing efficiency of the server/client computing environment. In one example, the system 800 can be associated with a data processing process and/or a data anonymization process.

In the embodiment shown in FIG. 8, the system 800 can include a server component 802. As shown in FIG. 8, the server component 802 can include an inference component 804 and a machine learning component 806. Aspects of the server component 802 can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. In an aspect, the server component 802 can also include memory 808 that stores computer executable components and instructions. Furthermore, the server component 802 can include a processor 810 to facilitate execution of the instructions (e.g., computer executable components and corresponding instructions) by the server component 802. As shown, the inference component 804, the machine learning component 806, the memory 808 and/or the processor 810 can be electrically and/or communicatively coupled to one another in one or more embodiments. In an embodiment, the server component 802 can be implemented on a server. Additionally, the server component 802 can be in communication with a client device. For instance, the server component 802 can be in communication with the server component 802.

The server component 802 (e.g., the inference component 804 of the server component 802) can receive anonymized data 812. In an embodiment, the anonymized data 812 can correspond to the anonymized data 714. For instance, the server component 802 can receive the anonymized data 812 from a client device. The anonymized data 812 can be a version of data where one or more identifying features are removed from the data. For example, the anonymized data 812 can be a version of the data 712 where one or more identifying features are removed from the data 712. In an embodiment, the inference component 804 can receive the anonymized data 812 where the anonymized data 812 is transformed from non-anonymized data based on a noise profile indicative of randomized data. The machine learning component 806 can learn from the anonymized data 812 to generate an updated anonymization strategy 814. For instance, the machine learning component 806 can learn from the anonymized data 812 based on a machine learning process associated with a probabilistic model that represents the anonymized data 812 and/or the data 712. In an embodiment, the machine learning component 806 can learn from randomized data associated with the anonymized data 812 to generate an updated noise profile for the anonymized data 812 and/or the data 712 based on a machine learning process associated with a probabilistic model that represents the anonymized data 812 and/or the data 712. The machine learning process employed by the machine learning component 806 can be associated with a machine learning network. For instance, the machine learning process can be a process that determines classifications, correlations, inferences and/or expressions associated with the anonymized data 812 and/or the data 712 based on principles of artificial intelligence and/or one or more machine learning techniques. In certain embodiments, the machine learning process can be a deep learning process associated with a deep learning network. The deep learning network can be an artificial neural network that employs deep learning to determine at least one feature associated with the anonymized data 812 and/or the data 712. The deep learning network can, for example, employ supervised learning to determine at least one feature associated with the anonymized data 812 and/or the data 712. Furthermore, the deep learning network can process information similar to a biological neuron system that employs a cascade of multiple layers of nonlinear processing where a first layer can employ output of a second layer as input for the first layer. In certain embodiments, the machine learning process can be a convolutional neural network process associated with a convolutional neural network. The convolutional neural network can be a feed-forward artificial neural network that employs deep learning to determine at least one feature associated with the anonymized data 812 and/or the data 712. Furthermore, the convolutional neural network can be a classifier associated with supervised learning to determine at least one feature associated with the anonymized data 812 and/or the data 712. For instance, the convolutional neural network can include a set of convolutional layers that apply one or more convolutional operations to the anonymized data 812 and/or the data 712. However, it is to be appreciated that in certain embodiments the machine learning component 806 can employ another type of machine learning process.

The probabilistic model associated with the machine learning process can be a model employed by the machine learning process to determine classifications, correlations, inferences and/or expressions associated with the data 112. The probabilistic model can employ a probabilistic distribution of the anonymized data 812 and/or the data 712 to determine classifications, correlations, inferences and/or expressions associated with the anonymized data 812 and/or the data 712. In an embodiment, the probabilistic model can be a statistical learning model that employs statistics and/or functional analysis to determine classifications, correlations, inferences and/or expressions associated with the anonymized data 812 and/or the data 712. In another embodiment, the probabilistic model can be a Bayesian network model that employs Bayesian statistics and/or a probabilistic graph that represents the anonymized data 812 and/or the data 712 to determine classifications, correlations, inferences and/or expressions associated with the anonymized data 812 and/or the data 712. In yet another embodiment, the probabilistic model can be a Markov chain model that employs a probability distribution represented as a Markov chain transition matrix associated with the anonymized data 812 and/or the data 712 to determine classifications, correlations, inferences and/or expressions associated with the anonymized data 812 and/or the data 712. As such, the machine learning component 806 can additionally or alternatively learn from the anonymized data 812 and/or the data 712 based on a statistical learning model, a Bayesian network model, and/or a Markov chain model. However, it is to be appreciated that in certain embodiments the machine learning component 806 can additionally or alternatively learn from the anonymized data 812 and/or the data 712 based on a different type of machine learning model.

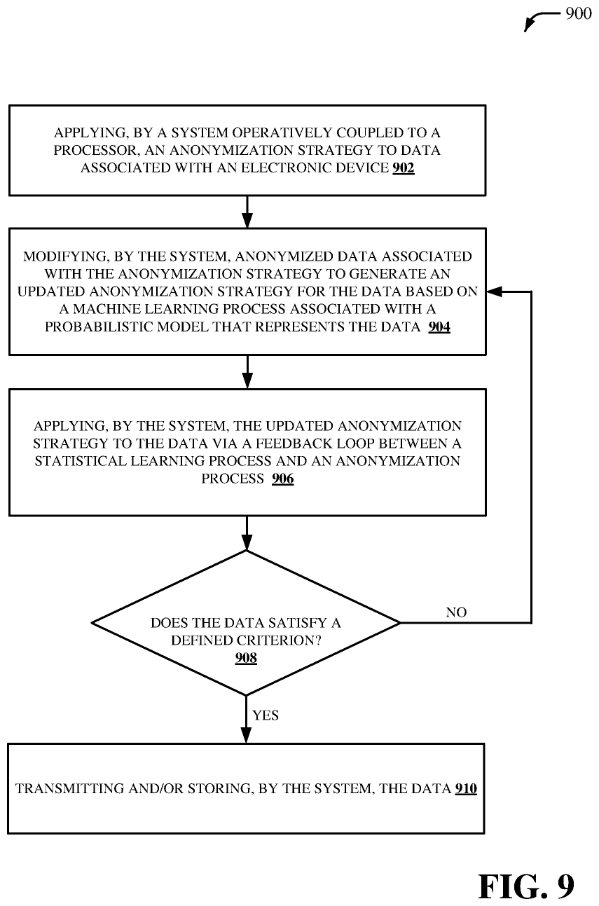

FIG. 9 illustrates a flow diagram of an example, non-limiting computer-implemented method 900 that facilitates adaptive anonymization of data using statistical inference in accordance with one or more embodiments described herein. At 902, an anonymization strategy is applied, by a system operatively coupled to a processor (e.g., by anonymization component 104), to data associated with an electronic device. The anonymization strategy can be an anonymization technique to remove one or more identifying features from the data. For instance, the anonymization strategy can be a statistical technique to remove one or more identifying features from the data. In one example, the anonymization strategy can be a differential privacy technique to remove one or more identifying features from the data. For instance, the anonymization strategy can be a differential privacy technique that adds randomized noise data to the data to remove one or more identifying features from the data. In an embodiment, the anonymization strategy can include anonymized data. The anonymized data associated with the anonymization strategy can be applied to the data to remove one or more identifying features from the data. In one example, the anonymized data can include randomized noise data. In another example, the anonymized data can include a set of parameters for the anonymization strategy. The electronic device can be a user device (e.g., a client device) such as, for example, a computing device, a computer, a desktop computer, a laptop computer, a monitor device, a smart device, a smart phone, a mobile device, a handheld device, a tablet, a wearable device, a portable computing device, a medical device, a sensor device, a controller device, and/or or another computing device. In certain embodiments, a noise profile indicative of randomized data can be applied to the data associated with the electronic device.

At 904, anonymized data associated with the anonymization strategy is learned from, by the system (e.g., by statistical learning component 106), to generate an updated anonymization strategy for the data based on a machine learning process associated with a probabilistic model that represents the data. The updated anonymization strategy can be an updated anonymization technique to remove one or more identifying features from the data. For instance, the updated anonymization strategy can be an updated statistical technique to remove one or more identifying features from the data. In one example, the updated anonymization strategy can be an updated differential privacy technique to remove one or more identifying features from the data. For instance, the updated anonymization strategy can be an updated differential privacy technique that adds updated randomized noise data to the data to remove one or more identifying features from the data. In an embodiment, the updated anonymization strategy can include updated anonymized data. The updated anonymized data associated with the updated anonymization strategy can be applied to the data to remove one or more identifying features from the data. In one example, the updated anonymized data can include the updated randomized noise data. In another example, the updated anonymized data can include a set of updated parameters for the updated anonymization strategy. In certain embodiments, the randomized data can be learned from to generate an updated noise profile for the data based on the machine learning process associated with the probabilistic model that represents the data.

The machine learning process can be associated with a machine learning network. For instance, the machine learning process can be a process that determines classifications, correlations, inferences and/or expressions associated with the data and/or the anonymized data based on principles of artificial intelligence and/or one or more machine learning techniques. In certain embodiments, the machine learning process can be a deep learning process associated with a deep learning network. The deep learning network can be an artificial neural network that employs deep learning to determine at least one feature associated with the data and/or the anonymized data. The deep learning network can, for example, employ supervised learning to determine at least one feature associated with the data and/or the anonymized data. Furthermore, the deep learning network can process information similar to a biological neuron system that employs a cascade of multiple layers of nonlinear processing where a first layer can employ output of a second layer as input for the first layer. In certain embodiments, the machine learning process can be a convolutional neural network process associated with a convolutional neural network. The convolutional neural network can be a feed-forward artificial neural network that employs deep learning to determine at least one feature associated with the data and/or the anonymized data. Furthermore, the convolutional neural network can be a classifier associated with supervised learning to determine at least one feature associated with the data and/or the anonymized data. For instance, the convolutional neural network can include a set of convolutional layers that apply one or more convolutional operations to the data and/or the anonymized data. The probabilistic model associated with the machine learning process can be a model employed by the machine learning process to determine classifications, correlations, inferences and/or expressions associated with the data and/or the anonymized data. The probabilistic model can employ a probabilistic distribution of the data to determine classifications, correlations, inferences and/or expressions associated with the data and/or the anonymized data. In an embodiment, the probabilistic model can be a statistical learning model that employs statistics and/or functional analysis to determine classifications, correlations, inferences and/or expressions associated with the data and/or the anonymized data. For instance, the learning from the anonymized data can include modifying the anonymization strategy based on a statistical learning model. In another embodiment, the probabilistic model can be a Bayesian network model that employs Bayesian statistics and/or a probabilistic graph that represents the data to determine classifications, correlations, inferences and/or expressions associated with the data and/or the anonymized data. For instance, the learning from the anonymized data can include modifying the anonymization strategy based on a Bayesian network model. In yet another embodiment, the probabilistic model can be a Markov chain model that employs a probability distribution represented as a Markov chain transition matrix associated with the data to determine classifications, correlations, inferences and/or expressions associated with the data and/or the anonymized data. For instance, the learning from the anonymized data can include modifying the anonymization strategy based on a Markov chain model.

At 906, the updated anonymization strategy is applied, by the system (e.g., by anonymization component 104), to the data via a feedback loop between a statistical learning process and an anonymization process.

At 908, it is determined whether the data satisfies a defined criterion. For instance, it can be determined whether the data is associated with a certain amount of anonymity. In one example, a measure of accuracy of the data can be performed where similarity of aggregate statistics on the data is determined before and after the anonymization strategy and/or the updated anonymization strategy is applied to the data. If no, the computer-implemented method 900 returns to 904. If yes, the computer-implemented method 900 proceeds to 910.

At 910, the data is transmitted and/or stored, by the system (e.g., by statistical learning component 106). For example, the data can be transmitted to an electronic device and/or to a network device. Additionally or alternatively, the data can be stored in a database. The data that is transmitted and/or stored can be a further anonymized version of the data. In an aspect, one or more identifying features included in the data that is transmitted and/or stored can be removed from the data that is transmitted and/or stored. In certain embodiments, the modifying the anonymized data can include providing improved anonymization for the data.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Moreover, because at least apply an anonymization strategy to data is established from a combination of electrical and mechanical components and circuitry, a human is unable to replicate or perform processing performed, for example, by the data processing component 102 (e.g., the anonymization component 104 and/or the statistical learning component 106) disclosed herein. For example, a human is unable to apply an anonymization strategy to data, apply an updated anonymization strategy to data, etc.

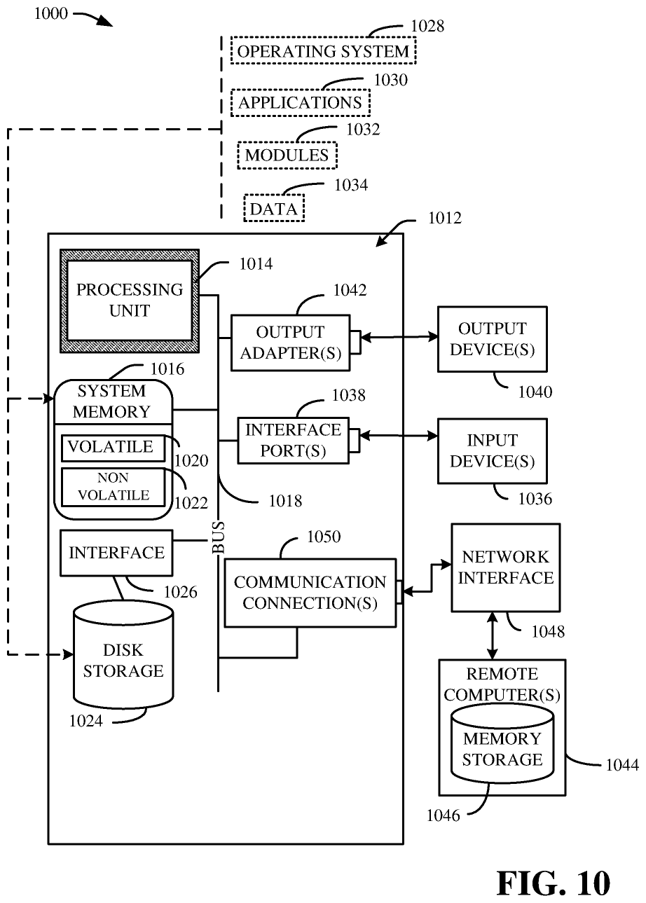

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity.

With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media. To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012.

System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

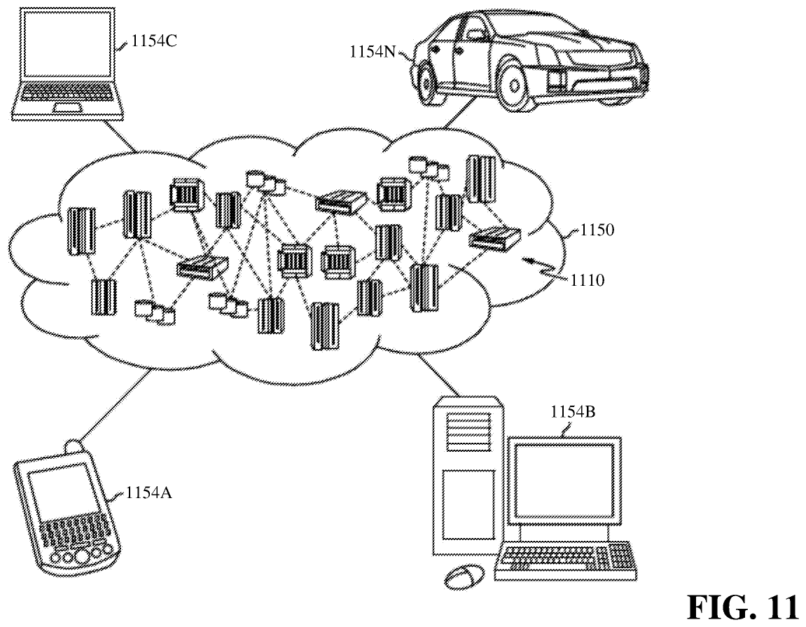

Referring now to FIG. 11, an illustrative cloud computing environment 1150 is depicted. As shown, cloud computing environment 1150 includes one or more cloud computing nodes 1110 with which local computing devices used by cloud consumers, such as, for example, personal digital assistant (PDA) or cellular telephone 1154A, desktop computer 1154B, laptop computer 1154C, and/or automobile computer system 1154N may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1150 to offer infrastructure, platforms and/or software as services for which a cloud consumer does not need to maintain resources on a local computing device. It is understood that the types of computing devices 1154A-N shown in FIG. 11 are intended to be illustrative only and that computing nodes 1110 and cloud computing environment 1150 can communicate with any type of computerized device over any type of network and/or network addressable connection (e.g., using a web browser).

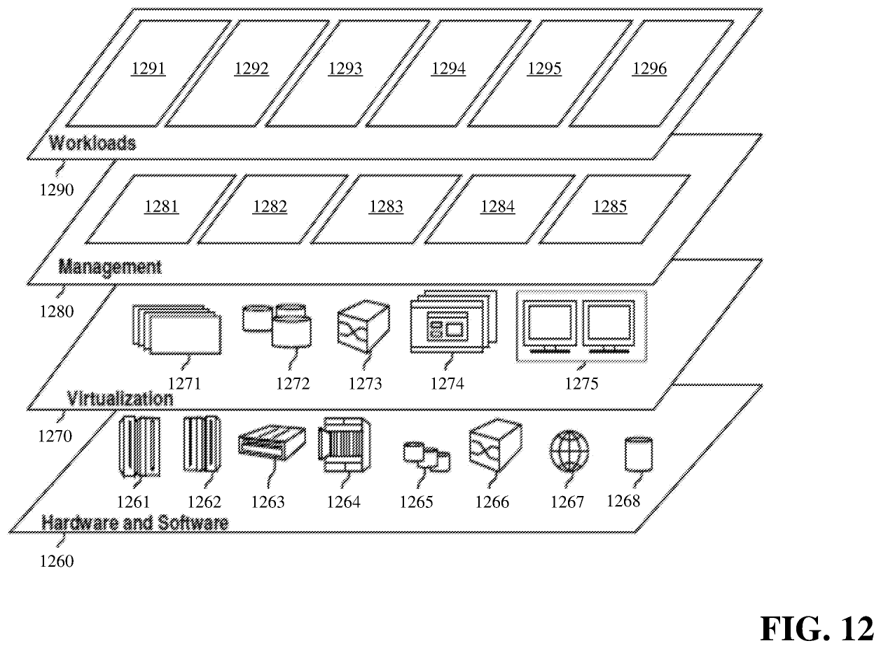

Referring now to FIG. 12, a set of functional abstraction layers provided by cloud computing environment 1150 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1260 includes hardware and software components. Examples of hardware components include: mainframes 1261; RISC (Reduced Instruction Set Computer) architecture based servers 1262; servers 1263; blade servers 1264; storage devices 1265; and networks and networking components 1266. In some embodiments, software components include network application server software 1267 and database software 1268.

Virtualization layer 1270 provides an abstraction layer from which the following examples of virtual entities may be provided: virtual servers 1271; virtual storage 1272; virtual networks 1273, including virtual private networks; virtual applications and operating systems 1274; and virtual clients 1275.

In one example, management layer 1280 may provide the functions described below. Resource provisioning 1281 provides dynamic procurement of computing resources and other resources that are utilized to perform tasks within the cloud computing environment. Metering and Pricing 1282 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1283 provides access to the cloud computing environment for consumers and system administrators. Service level management 1284 provides cloud computing resource allocation and management such that required service levels are met. Service Level Agreement (SLA) planning and fulfillment 1285 provide pre-arrangement for, and procurement of, cloud computing resources for which a future requirement is anticipated in accordance with an SLA.

Workloads layer 1290 provides examples of functionality for which the cloud computing environment may be utilized. Non-limiting examples of workloads and functions which may be provided from this layer include: mapping and navigation 1291; software development and lifecycle management 1292; virtual classroom education delivery 1293; data analytics processing 1294; transaction processing 1295; and data anonymization process software 1296.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes computer executable components stored in the memory, wherein the computer executable components comprise:
an anonymization component that applies an anonymization strategy to data associated with an electronic device; and
a statistical learning component that modifies the anonymization strategy to generate an updated anonymization strategy for the data based on a machine learning process associated with a probabilistic model that represents the data.

2. The system of claim 1, wherein the anonymization component applies the updated anonymization strategy to the data via a feedback loop between the statistical learning component and the anonymization component.

3. The system of claim 1, wherein the statistical learning component modifies the anonymization strategy based on a statistical learning model.

4. The system of claim 1, wherein the statistical learning component modifies the anonymized data based on a Bayesian network model.

5. The system of claim 1, wherein the statistical learning component modifies the anonymization strategy based on a Markov chain model.

6. The system of claim 1, wherein the statistical learning component modifies the anonymization strategy in response to a determination that a timer satisfies a defined criterion.

7. The system of claim 1, wherein the statistical learning component modifies the machine learning process in response to a determination that a timer satisfies a defined criterion.

8. The system of claim 1, wherein the electronic device is a first electronic device, and wherein the statistical learning component trains the machine learning process based on training data received from a second electronic device.

9. The system of claim 1, wherein the anonymization component applies a noise profile indicative of randomized data to the data associated with the electronic device.

10. The system of claim 9, wherein the statistical learning component learns from the randomized data to generate an updated noise profile for the data based on the machine learning process associated with the probabilistic model that represents the data.

11. The system of claim 10, wherein the statistical learning component generates the updated anonymization strategy for the data to provide improved anonymization for the data.

12. A computer-implemented method, comprising:
applying, by a system operatively coupled to a processor, an anonymization strategy to data associated with an electronic device; and
learning, by the system, from anonymized data associated with the anonymization strategy to generate an updated anonymization strategy for the data based on a machine learning process associated with a probabilistic model that represents the data.

13. The computer-implemented method of claim 12, further comprising:
applying, by the system, the updated anonymization strategy to the data via a feedback loop between a statistical learning process and an anonymization process.

14. The computer-implemented method of claim 12, wherein the learning from the anonymized data comprises modifying the anonymization strategy based on a statistical learning model.

15. The computer-implemented method of claim 12, wherein the applying the anonymization strategy to the data comprises applying a noise profile indicative of randomized data to the data associated with the electronic device.

16. The computer-implemented method of claim 15, wherein the learning from the anonymized data comprises modifying the randomized data to generate an updated noise profile for the data based on the machine learning process associated with the probabilistic model that represents the data.

17. The computer-implemented method of claim 12, wherein the modifying the anonymization strategy comprises providing improved anonymization for the data.

18. A computer program product facilitating adaptive anonymization using statistical inference, the computer program product comprising a computer readable storage medium having program instructions embodied therewith, the program instructions executable by a processor to cause the processor to:
apply, by the processor, a noise profile indicative of randomized data to data associated with an electronic device; and
learn, by the processor, from the randomized data to generate an updated noise profile for the data based on a machine learning process associated with a probabilistic model that represents the data.

19. The computer program product of claim 18, wherein the program instructions are further executable by the processor to cause the processor to:
learn, by the processor, from the randomized data based on a statistical learning model.

20. The computer program product of claim 18, wherein the electronic device is a first electronic device, and wherein the program instructions are further executable by the processor to cause the processor to:
train, by the processor, the machine learning process based on training data received from a second electronic device.
